(19) United States
(12) Patent Application Publication
(10) Pub. No.: US 2026/0350262 A1
(43) Pub. Date: Nov. 5, 2026

(54) WILDFIRE EVALUATION SYSTEMS AND METHODS

(71) Applicant: Inventus Holdings, LLC, Juno Beach, FL (US)

(72) Inventors: Keith J. Harding, Minneapolis, MN (US); Richard Walker, JR., Lakeville, MN (US); Aaron P. Bloom, Mahtomedi, MN (US); Robert J. Conzemius, Grand Rapids, MN (US); David M. Elliott, Coleraine, MN (US); Jordan R. Love, Madisonville, KY (US); Jennifer D. Chaney, Jupiter, FL (US); Jacob J. Alberti, Buda, TX (US)

(21) Appl. No.: 19/197,498

(22) Filed: May 2, 2025

(51) Int. Cl. G06F 30/20

(52) U.S. Cl. CPC G06F 30/20

(57) ABSTRACT

The disclosed technology includes systems and methods for evaluating wildfire risk. The disclosed systems and methods can comprise identifying at-risk areas from satellite data and using a machine learning algorithm to calculate a wildfire risk for each of the at-risk areas by weighing attributes of the at-risk areas. The disclosed systems and methods can further comprise calculating an alert index for each of the at-risk areas to determine whether an alert for the wildfire risk is warranted and automatically transmit a notification to computing devices in the at-risk areas upon the alert index exceeding a predetermined threshold.

### FIELD OF THE DISCLOSURE

The various embodiments of the present disclosure relate generally to systems and methods for evaluating wildfire conditions and predicting wildfire behavior, and more particularly to systems and methods for evaluating wildfire risk and dynamically transmitting alerts to one or more at-risk areas.

### BACKGROUND

Wildfires are becoming a very large risk for asset owners/operators (e.g., transmission assets, renewable energy assets, other electrical infrastructure, etc.) in fire-prone areas. Operators of such assets need the ability to have situational awareness about upcoming wildfire risk to their assets so they can harden infrastructure, move vulnerable personnel to safety, and/or position preventative equipment/personnel in high-risk areas (e.g., firefighting equipment). Similarly, asset owners in such areas need to be aware of relatively low wildfire risk periods to conduct work with increased fire ignition risk (e.g., welding, driving vehicles over vegetation, conducting controlled burns, etc.) during times with low risk of explosive wildfire growth.

Furthermore, in some jurisdictions, electric grid operators are required to have a fire prevention plan to prevent the ignition of wildfires from electric grid infrastructure. The fire prevention plan can utilize a fire weather index using satellite data or on-site data to estimate fuel dryness, state of native grasses, and short-term weather forecasts to estimate the short-term potential of explosive wildfires. However, it is desirable to provide more accurate predictions of wildfire potential to reduce wildfires, limit line shutdowns, and ensure compliance.

Accordingly, there is a need for improved systems and methods for evaluating wildfire risk. Embodiments of the present disclosure are directed to this and other considerations.

### BRIEF SUMMARY

An exemplary embodiment of the present disclosure provides a wildfire evaluation system and method comprising: receiving satellite data for a geographic perimeter including weather data and vegetation data; identifying, using a machine learning algorithm, one or more at-risk areas in the satellite data based on the weather data and the vegetation data; calculating, by the machine learning algorithm, a wildfire risk for each of the one or more at-risk areas, the calculating including weighting one or more attributes associated with the satellite data and the one or more at-risk areas; calculating, by an alert engine, an alert index for each of the one or more at-risk areas based on the wildfire risk; and automatically transmitting, by the alert engine, a notification to one or more computing devices in each of the one or more at-risk areas having an alert index greater than a predetermined threshold.

In any of the embodiments disclosed herein, the system and method can further comprise training the machine learning algorithm with (i) user inputted data comprising a data set of user-identified at-risk areas, (ii) associated behavioral characteristics of the user-identified at-risk areas, and (iii) geographical data of the data set.

In any of the embodiments disclosed herein, the one or more attributes weighted for each of the one or more at-risk areas can include historical wildfire data, soil characteristics, land cover data, the weather data, the vegetation data, and an indication of an ongoing wildfire.

In any of the embodiments disclosed herein, the alert engine can override the predetermined threshold for each of the one or more at risk-areas having the indication of the ongoing wildfire.

In any of the embodiments disclosed herein, the alert index can be calculated based on an output from a fire behavior model, the fire behavior model being configured to automatically output the output upon receiving the weather data and the vegetation data included in the satellite data.

In any of the embodiments disclosed herein, the one or more computing devices receiving the alert can be associated with one or more electric grid assets.

In any of the embodiments disclosed herein, each of the one or more electric grid assets can be assigned a priority by the alert engine, and wherein the priority is weighted with the one or more attributes associated with the satellite data and the one or more at-risk areas.

Another embodiment of the present disclosure provides a wildfire detection system and method comprising: receiving satellite data for a geographic perimeter including weather data and vegetation data; identifying, using a machine learning algorithm, one or more at-risk areas in the satellite data based on the weather data and the vegetation data; calculating, by the machine learning algorithm, a wildfire risk for each of the one or more at-risk areas, the calculating including weighting one or more attributes associated with the satellite data and the one or more at-risk areas; calculating, by an alert engine, an alert index for each of the one or more at-risk areas based on the wildfire risk; and automatically transmitting, by the alert engine, a notification to one or more computing devices associated with one or more electric grid assets in each of the one or more at-risk areas having an alert index greater than a predetermined threshold.

In any of the embodiments disclosed herein, the system and method can comprise: receiving electric grid data comprising an indication of the one or more electric grid assets; and receiving data indicative of maintenance work on the one or more of the electric grid assets, wherein the alert engine overrides the predetermined threshold for each of the one or more electric grid assets having the indication of the maintenance work.

In any of the embodiments disclosed herein, the system and method can further comprise training the machine learning algorithm with (i) user inputted data comprising a data set of user-identified at-risk areas, (ii) associated behavioral characteristics of the user-identified at-risk areas, and (iii) geographical data of the data set.

In any of the embodiments disclosed herein, the one or more attributes weighted for each of the one or more at-risk areas can include historical wildfire data, soil characteristics, land cover data, the weather data, the vegetation data, and an indication of an ongoing wildfire.

In any of the embodiments disclosed herein, the alert engine can override the predetermined threshold for each of the one or more at risk-areas having the indication of the ongoing wildfire.

In any of the embodiments disclosed herein, the alert index can be calculated based on an output from a fire behavior model, the fire behavior model being configured to automatically output the output upon receiving the weather data and the vegetation data included in the satellite data.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 is a system diagram of a wildfire evaluation system in accordance with the present disclosure.

FIG. 2 is a block diagram of a computing device used by a wildfire evaluation system in accordance with the present disclosure.

FIG. 3 is a flowchart illustrating a wildfire evaluation method in accordance with the present disclosure.

### DETAILED DESCRIPTION

Disclosed herein are methods and systems that provide for the identification of one or more at-risk areas for wildfires. Such systems and methods can use data such as satellite data to determine the risk of explosive wildfire growth, how conducive weather conditions are to explosive wildfire spread, and a risk posed by ongoing or active wildfires. These systems and methods can be configured to work in different biomes and can be modular in their application to provide users with flexibility. Additionally, the determined risk can be used in an alerting system that can provide alerts to configurable groups of recipients or geographical areas based in part on the calculated risks.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” can be used herein to connote different aspects of methods employed, the term should not be interpreted as implying any particular order among or between various steps herein disclosed unless and except when the order of individual steps is explicitly required. Further, the disclosed technology does not necessarily require all steps included in the methods and processes described herein. That is, the disclosed technology includes methods that omit one or more steps expressly discussed with respect to the methods described herein.

Reference will now be made in detail to example embodiments of the disclosed technology that are illustrated in the accompanying drawings and disclosed herein. Wherever convenient, the same reference numbers will be used throughout the drawings to refer to the same or like parts.

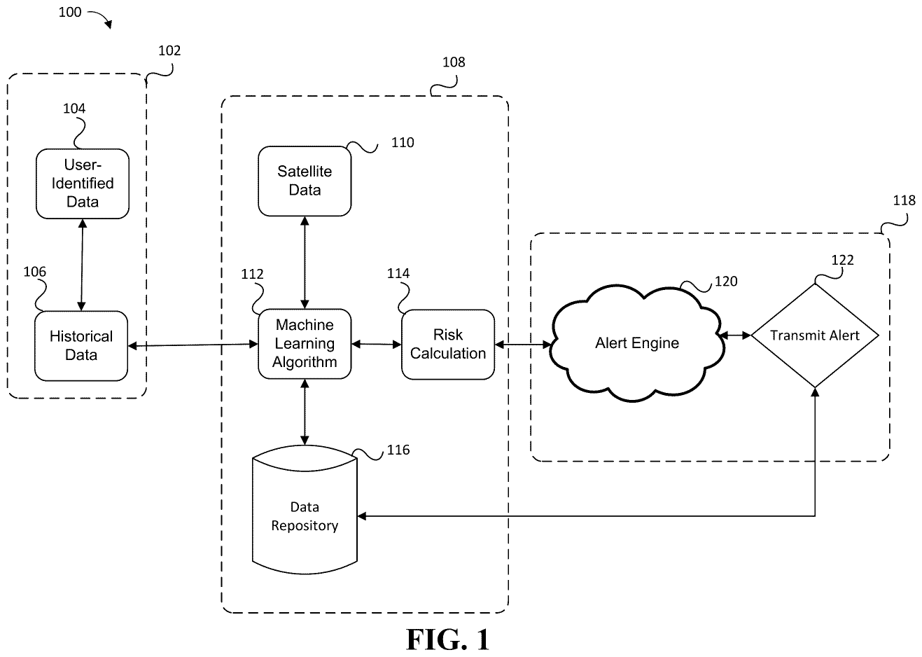

FIG. 1 illustrates an example system 100 for wildfire evaluation. One of skill in the art will appreciate that the various features of the system 100 described herein can be incorporated into a single computing device or be divided into distinct parts across a network of computing devices. Thus, although the various features of the system 100 may be described as separate and distinct features or components, the described technology is not so limited.

Systems and methods for wildfire evaluation are discussed herein. Wildfire evaluation may be desirable for monitoring related to energy generation sites. As can be appreciated, energy generation sites can include fossil fuel power plants, nuclear power plants, and renewable energy sites. Further, renewable energy sites can include wind plants, solar plants, hydroelectric plants, geothermal power plants, and any other sources of renewable energy generation known in the art. Any system and method for wildfire detection can relate to monitoring a location of interest, including any examples of energy generation sites discussed herein

The system 100 includes a training program 102 that can be configured to produce training data for the evaluation of wildfire risk in real-time. The training program 102 can be configured to receive user-identified data 104 related to a wildfire. The user-identified data 104 can include satellite data, weather data, land cover data, and/or vegetation data. The user-identified data 104, in some embodiments, can be received by the training program 102 via a grid operator. The grid operator, in some embodiments, can be an independent system operator (ISO) or a regional transmission organization (RTO). That is, the ISO or RTO may produce the user-identified data 104 and allow the training program 102 access to the user-identified data 104. In some embodiments, the user-identified data 104 can be determined via the system 100.

The training program 102 can further be configured to receive historical data 106. The historical data 106 can include historical satellite data, weather data, land cover data, and/or vegetation data. The historical data 106 may be unannotated, or the historical data 106 may contain annotations in the form of the user-identified data. User-identified data is data that has been modified, reviewed, or altered by a user. In such a manner, the training program 102 can provide the historical data 106 along with the user-identified data 104 to previous wildfire risks along with the historical context of whether or not previous wildfire risks led to an actual wildfire.

The system 100 can include a detection application 108. The detection application 108 can be configured to receive satellite data 110. The satellite data 110 can be real-time satellite data, as opposed to the historical satellite data from the training program 102. As can be appreciated, the system 100 can further include a user interface that can be configured to receive inputs from a user and display data for the user to view. As a non-limiting example, the user interface can be a screen of a computing device that is configured to display data for the user. The user interface can receive an input from a user, for example, by a touch screen, a mouse, a keyboard, or other methods of inputting data to a user interface as is known in the art.

The detection application 108 includes a machine learning algorithm 112 configured to generate the risk calculation 114 for one or more at-risk areas that is trained on observed relationships between historical vegetation data, weather data, and historical fire burn rates. The one or more at-risk areas can be geographic perimeters. The machine learning algorithm 112 can be implemented by any embodiments of computing devices discussed herein. The machine learning algorithm 112 can be configured to receive the satellite data 110 for the geographic perimeters. The machine learning algorithm 112 can be in communication with the training program 102, such that the machine learning algorithm 112 can be configured to train on the user-identified data 104 and the historical data 106 from the training program 102. That is, the machine learning algorithm 112 can train in a supervised or unsupervised learning manner.

Further, the machine learning algorithm 112 can be configured to identify one or more at-risk areas in the satellite data 110, which includes weather data and vegetation data. The satellite data 110 can also include camera data, such as visual images (for smoke detection) and/or thermal and other infrared imaging camera data for the geographic perimeters. The machine learning algorithm 112 can do so based on the identification of at-risk areas in the historical data 106 or user-identified risk areas in the user-identified data 104. The machine learning algorithm 112 can further do so based on occurrences of wildfires in the historical data 106 and/or based on user-identified wildfires in the user-identified data 104.

The machine learning algorithm 112 can be in communication with a data repository 116. That is, the detection application 108 can further include the data repository 116. The data repository 116 can be configured to store data that may be used by the machine learning algorithm 112 to generate the risk calculation 114. In some embodiments, the data repository 116 can include historical data including previously identified wildfires by the machine learning algorithm 112. The data repository 116 may include electric grid data, such as grid operator regions, ISO/RTO regions, ISO/RTO locations, substation locations, substation capacities, node locations, hubs associated with each node, electrical components associated with each node, and similar data related to a general layout of the electric grid.

The detection application 108 can be configured to output the risk calculation 114. That is, the machine learning algorithm 112 of the detection application 108 can be configured to generate the risk calculation 114. The risk calculation 114 can contain a wildfire risk for each of the one or more at-risk areas in the satellite data 110, which were identified by the machine learning algorithm 112.

The risk calculation 114 can also comprise a fire behavior model that is informed by theoretical spread rates associated with land cover types and adjusted to account for variations in forecasted weather data, with final weightings based on observed relationships between land cover and weather impacts on wildfire growth. The fire behavior model can calculate a predicted spread of the wildfire to be output with the risk calculation 114. The fire behavior model can intake data such as weather data, land cover data, and/or vegetation data to calculate a predicted spread of the wildfire. The fire behavior model can then determine a future position of a wildfire based on the previously calculated position of the wildfire and the predicted spread of the wildfire. Then, the fire behavior model can determine that the future position of the wildfire should be included in the one or more at-risk areas due to the future position of the wildfire, and the identification can be returned to the machine learning algorithm 112 to include in the training program 102.

The risk calculation 114 can be based at least in part on one or more attributes that are weighted for each of the one or more at-risk areas. The one or more attributes can be associated with the satellite data 110, such as land cover, vegetation, weather, etc.

The risk calculation 114 can be submitted to an alert program 118. The alert program 118 can include an alert engine 120. The alert engine 120 can be configured to receive the risk calculation 114, which can include the identification of the one or more at-risk areas from the machine learning algorithm 112 as well as the wildfire risk calculated in the risk calculation 114. The alert engine 120 can also receive the future position of the wildfire and the additional at-risk areas identified in the risk calculation 114.

The alert engine 120 can, in some examples, automatically transmit an alert 122. In other examples, the alert engine 120 can weigh various parameters, such as the relative risk of explosive wildfire growth based on a multivariate calculation of risk using various weather variables that is received with the risk calculation 114, to determine whether or not to transmit the alert 122. In other examples still, the alert engine 120 can be configured to override any decision and automatically transmit the alert 122 upon receiving the determination of a wildfire from the risk calculation 114.

The determination of whether or not to transmit the alert 122 can be based upon the alert engine 120 calculating an alert index for each of the one or more at-risk areas. For instance, the alert engine 120 can calculate the relative risk of explosive wildfire growth based on a multivariate calculation of risk using various weather variables, such as those received from the satellite data 110. In other examples, the alert engine 120 can determine whether or not to transmit the alert 122 if the relative risk of an explosive wildfire is greater than a tunable threshold, if a large wildfire has been observed within a tunable radius of a geographic object, if a fire is forecasted to rapidly grow near a geographic object, if a wildfire is expected to rapidly move towards a geographic object, or if a wildfire alert has been issued by a public weather forecasting entity.

The alert program 118 can be configured to transmit an alert 122. The alert 122, as understood by those skilled in the art, can include a notification or other similar form of communication between two computing devices. The alert 122 including the risk calculation 114 can be recorded and stored in the data repository 116 as part of the historical data.

The system 100 can include an application that can be in communication with the user interface and the machine learning model 112. As non-limiting examples, the application can be an extension of a browser, a software program, a program or feature of a kernel of the system, or any computer application that can perform the functions described herein.

As will be appreciated, as the machine learning model 112 is trained and becomes more accurate over time, the amount of frequency of user inputs of the user-identified data 104 can be reduced. In other words, as the machine learning model 112 becomes more accurate over time, the need for human oversight of the machine learning model 112 can decrease and the machine learning model 112 can operate largely unsupervised.

The machine learning model 112 can be or include a neural network, a recurrent neural network, a Long Short-Term Memory (LSTM) network, a bi-direction LSTM network, a Conditional Random Fields (CRF) network, an LSTM-CRF network, a Bi-LSTM-CRF network, or other suitable machine learning models. In some embodiments, the machine learning model 112 can employ a gradient boosting model, a light gradient boosting model, or similar models known in the art.

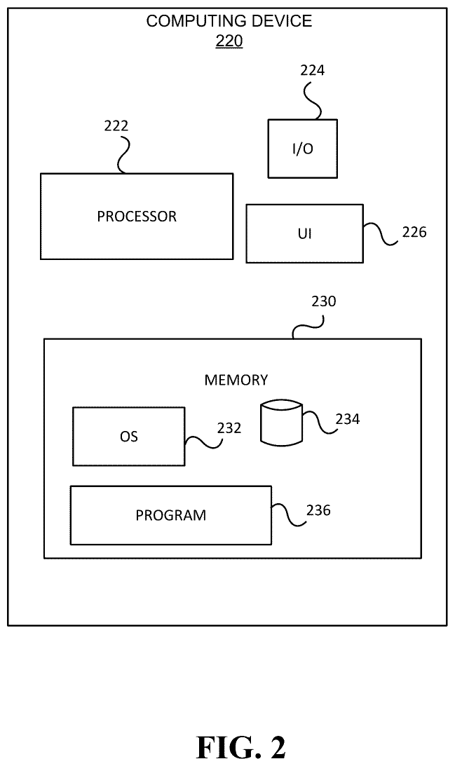

FIG. 2 illustrates an example computing device for wildfire evaluation, in accordance with examples of the disclosed technology. As will be appreciated by one of skill in the art, the computing device 220 can be configured to include all or some of the features described in relation to the system 100. As shown, the computing device 220 may include a processor 222, an input/output (“I/O”) device 224, a memory 230 containing an operating system (“OS”) 232 and a program 236. In certain example implementations, the computing device 220 may be a single server or may be configured as a distributed computer system including multiple servers or computers that interoperate to perform one or more of the processes and functionalities associated with the disclosed embodiments. In some embodiments, computing device 220 may be one or more servers from a serverless or scaling server system. In some embodiments, the computing device 220 may further include a peripheral interface, a transceiver, a mobile network interface in communication with the processor 222, a bus configured to facilitate communication between the various components of the computing device 220, and a power source configured to power one or more components of the computing device 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 222 to communicate with other devices via wired or wireless networks, whether local or wide area, private or public, as known in the art. A power source may be configured to provide an appropriate alternating current (AC) or direct current (DC) to power components.

The processor 222 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 222 may be one or more known processing devices, such as, but not limited to, a microprocessor from the Pentium™ family manufactured by Intel™ or the Turion™ family manufactured by AMD™. The processor 222 may constitute a single core or multiple core processor that executes parallel processes simultaneously. For example, the processor 222 may be a single core processor that is configured with virtual processing technologies. In certain embodiments, the processor 222 may use logical processors to simultaneously execute and control multiple processes. The processor 222 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the computing device 220 may include one or more storage devices configured to store information used by the processor 222 (or other components) to perform certain functions related to the disclosed embodiments. In one example, the computing device 220 may include the memory 230 that includes instructions to enable the processor 222 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the computing device 220 may include a memory 230 that includes instructions that, when executed by the processor 222, perform one or more processes consistent with the functionalities disclosed herein. Methods, systems, and articles of manufacture consistent with disclosed embodiments are not limited to separate programs or computers configured to perform dedicated tasks. For example, the computing device 220 may include the memory 230 that may include one or more programs 236 to perform one or more functions of the disclosed embodiments.

The processor 222 may execute one or more programs located remotely from the computing device 220. For example, the computing device 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 222, perform one or more processes consistent with the disclosed embodiments. In some examples, the memory 230 may include a database 234 configured to store various data described herein. For example, the database 234 can be the data repository 116.

The computing device 220 may also be communicatively connected to one or more memory devices (e.g., databases) locally or through a network. The remote memory devices may be configured to store information and may be accessed and/or managed by the computing device 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The computing device 220 may also include one or more I/O devices 224 that may comprise one or more user interfaces 226 (e.g., user interface) for receiving signals or input from devices and providing signals or output to one or more devices that allow data to be received and/or transmitted by the computing device 220. For example, the computing device 220 may include interface components, which may provide interfaces to one or more input devices, such as one or more keyboards, mouse devices, touch screens, track pads, trackballs, scroll wheels, digital cameras, microphones, sensors, and the like, that enable the computing device 220 to receive data from a user.

In example embodiments of the disclosed technology, the computing device 220 may include any number of hardware and/or software applications that are executed to facilitate any of the operations. The one or more I/O devices 224 may be utilized to receive or collect data and/or user instructions from a wide variety of input devices. Received data may be processed by one or more computer processors as desired in various implementations of the disclosed technology and/or stored in one or more memory devices.

While the computing device 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the computing device 220 may include a greater or lesser number of components than those illustrated.

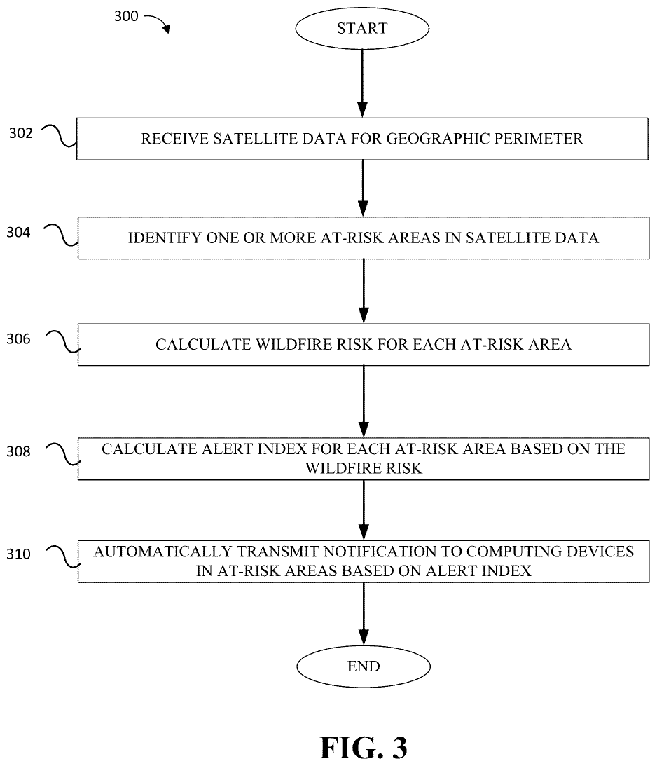

FIG. 3 is a flow diagram illustrating a wildfire evaluation method 300. While the method 300 is described with respect to the detection application 108 and the components therein, it is understood that the method 300 can be carried out on other computing devices, such as the computing device 220, or other such computing devices.

The method 300 comprises receiving 302 satellite data, such as the satellite data 110. The satellite data includes heat signature data and can further include other forms of data, such as weather data, vegetation data, and land cover data.

The method 300 then comprises identifying 304 one or more at-risk areas in the satellite data based on the weather data and the vegetation data. For example, the machine learning algorithm 112 can receive data indicative of low relative humidity and strong winds from the weather data, as well as dry vegetation data, and the machine learning algorithm 112 can designate such an area as an at-risk area. The machine learning algorithm 112 learns to identify the at-risk areas by training on the user-identified data 104, which comprises a data set of user-identified at-risk areas and their associated fire risks. The machine learning algorithm 112 also receives associated behavior characteristics of the user-identified at-risk areas from, for instance, the historical data 106. For example, the historical data 106 can contain weather data for the date on which the user-identified data 104 identified an area to be an at-risk area. Additionally, the machine learning algorithm 112 can also receive geographical data for the user-identified data 104, which can also be obtained from the historical data 106.

The method 300 then comprises calculating 306 a wildfire risk for each of the one or more identified at-risk areas. As described above, the calculation can be accomplished through weighing of one or more attributes in the fire behavior model. The one or more attributes weighted for each of the one or more at-risk areas can include, for example, historical wildfire data, soil characteristics, land cover data, the weather data, the vegetation data, and an indication of an ongoing wildfire.

In some examples, the fire behavior model may automatically output the risk calculation upon receiving weather data included in the satellite data 110. In other words, regardless of if the machine learning algorithm 112 identifying the at-risk areas, the fire behavior model can nevertheless perform the risk calculation of any potential wildfires that might occur for any location in the satellite data 110 based on the weather data and the satellite data 110. In such a manner, the fire behavior model may determine a fire risk index for a given area automatically. However, an alert is not necessarily sent until the machine learning algorithm 112 identifies the at-risk areas.

The method 300 then comprises calculating 308 an alert index for each of the one or more at-risk areas based on the wildfire risk. The alert index can additionally include a multivariate index based on one or more vegetation and weather characteristics, recent fire growth near a geographic object, forecasted fire growth near a geographic object, or forecasted fire movement towards a geographic object above a tunable threshold.

The method 300 then comprises automatically transmitting 310 an alert to one or more computing devices in each of the one or more at-risk areas that has an alert index greater than a predetermined threshold. The alert can be automatically transmitted, and the alert index overridden, if any of the at-risk areas has an indication of an ongoing wildfire. In some examples, the alert is transmitted to a computing device associated with a particular location of interest. In other examples, the alert is transmitted to all computing devices within the at-risk area. The location of interest can be selected from the data repository 116. In some examples, the location of interest is an electric grid asset, such as an energy generation site. As can be appreciated, energy generation sites can include fossil fuel power plants, nuclear power plants, and renewable energy sites. Further, renewable energy sites can include wind plants, solar plants, hydroelectric plants, geothermal power plants, and any other sources of renewable energy generation known in the art. Other locations of interest contained in the data repository 116 can include other electric grid assets such as grid operator regions, ISO/RTO regions, ISO/RTO locations, substation locations, substation capacities, node locations, hubs associated with each node, electrical components associated with each node, and similar data related to a general layout of the electric grid.

In some examples, the method 300 can further comprise receiving electric grid data from the data repository 116 that includes an indication of the one or more electric grid assets, as well as data indicative of maintenance work to be performed on the one or more electric grid assets. The alert can be automatically transmitted, and the alert index overridden, for each of the one or more electric grid assets having the indication of maintenance work. Alternatively, or in addition, each of the one or more electric grid assets can be assigned a priority by the alert engine 120. When the alert engine 120 is weighing the attributes to determine the alert index, the alert engine 120 can take into account the priorities of the one or more electric grid assets in the at-risk areas.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A wildfire evaluation method comprising:
receiving satellite data for a geographic perimeter including weather data and vegetation data;
identifying, using a machine learning algorithm, one or more at-risk areas in the satellite data based on the weather data and the vegetation data;
calculating, by the machine learning algorithm, a wildfire risk for each of the one or more at-risk areas, the calculating including weighting one or more attributes associated with the satellite data and the one or more at-risk areas;
calculating, by an alert engine, an alert index for each of the one or more at-risk areas based on the wildfire risk; and
automatically transmitting, by the alert engine, a notification to one or more computing devices in each of the one or more at-risk areas having an alert index greater than a predetermined threshold.

2. The method of claim 1, further comprising:
training the machine learning algorithm with (i) user inputted data comprising a data set of user-identified at-risk areas, (ii) associated behavioral characteristics of the user-identified at-risk areas, and (iii) geographical data of the data set.

3. The method of claim 1, wherein the one or more attributes weighted for each of the one or more at-risk areas includes historical wildfire data, soil characteristics, land cover data, the weather data, the vegetation data, and an indication of an ongoing wildfire.

4. The method of claim 3, wherein the alert engine overrides the predetermined threshold for each of the one or more at risk-areas having the indication of the ongoing wildfire.

5. The method of claim 1, wherein the alert index is calculated based on an output from a fire behavior model, the fire behavior model being configured to automatically output the output upon receiving the weather data and the vegetation data included in the satellite data.

6. The method of claim 1, wherein the one or more computing devices receiving the alert are associated with one or more electric grid assets.

7. The method of claim 6, wherein each of the one or more electric grid assets is assigned a priority by the alert engine, and wherein the priority is weighted with the one or more attributes associated with the satellite data and the one or more at-risk areas.

8. A wildfire evaluation system comprising:
a processor;
a memory storing instructions that, when executed by the processor, cause the wildfire evaluation system to:
receive satellite data for a geographic perimeter including weather data and vegetation data;
identify, using a machine learning algorithm, one or more at-risk areas in the satellite data based on the weather data and the vegetation data;
calculate, by the machine learning algorithm, a wildfire risk for each of the one or more at-risk areas, the calculating including weighting one or more attributes associated with the satellite data and the one or more at-risk areas;
calculate, by an alert engine, an alert index for each of the one or more at-risk areas based on the wildfire risk; and
automatically transmit, by the alert engine, a notification to one or more computing devices in each of the one or more at-risk areas having an alert index greater than a predetermined threshold.

9. The system of claim 8, wherein the instructions further cause the system to:
train the machine learning algorithm with (i) user inputted data comprising a data set of user-identified at-risk areas, (ii) associated behavioral characteristics of the user-identified at-risk areas, and (iii) geographical data of the data set.

10. The system of claim 8, wherein the one or more attributes weighted for each of the one or more at-risk areas includes historical wildfire data, soil characteristics, land cover data, the weather data, the vegetation data, and an indication of an ongoing wildfire.

11. The system of claim 10, wherein the alert engine overrides the predetermined threshold for each of the one or more at risk-areas having the indication of the ongoing wildfire.

12. The system of claim 8, wherein the alert index is calculated based on an output from a fire behavior model, the fire behavior model being configured to automatically output the output upon receiving the weather data and the vegetation data included in the satellite data.

13. The system of claim 8, wherein the one or more computing devices receiving the alert are associated with one or more electric grid assets.

14. The system of claim 13, wherein each of the one or more electric grid assets is assigned a priority by the alert engine, and wherein the priority is weighted with the one or more attributes associated with the satellite data and the one or more at-risk areas.

15. A wildfire evaluation method comprising:
receiving satellite data for a geographic perimeter including weather data and vegetation data;
identifying, using a machine learning algorithm, one or more at-risk areas in the satellite data based on the weather data and the vegetation data;
calculating, by the machine learning algorithm, a wildfire risk for each of the one or more at-risk areas, the calculating including weighting one or more attributes associated with the satellite data and the one or more at-risk areas;
calculating, by an alert engine, an alert index for each of the one or more at-risk areas based on the wildfire risk; and
automatically transmitting, by the alert engine, a notification to one or more computing devices associated with one or more electric grid assets in each of the one or more at-risk areas having an alert index greater than a predetermined threshold.

16. The method of claim 15, further comprising:
receiving electric grid data comprising an indication of the one or more electric grid assets; and
receiving data indicative of maintenance work on the one or more of the electric grid assets,
wherein the alert engine overrides the predetermined threshold for each of the one or more electric grid assets having the indication of the maintenance work.

17. The method of claim 15, further comprising:
training the machine learning algorithm with (i) user inputted data comprising a data set of user-identified at-risk areas, (ii) associated behavioral characteristics of the user-identified at-risk areas, and (iii) geographical data of the data set.

18. The method of claim 15, wherein the one or more attributes weighted for each of the one or more at-risk areas includes historical wildfire data, soil characteristics, land cover data, the weather data, the vegetation data, and an indication of an ongoing wildfire.

19. The method of claim 18, wherein the alert engine overrides the predetermined threshold for each of the one or more at risk-areas having the indication of the ongoing wildfire.

20. The method of claim 15, wherein the alert index is calculated based on an output from a fire behavior model, the fire behavior model being configured to automatically output the output upon receiving the weather data and the vegetation data included in the satellite data.
